(19) United States
(12) Patent Application Publication
(10) Pub. No.: US 2002/0103672 A1
(43) Pub. Date: Aug. 1, 2002

(54) Pre-paid health care system and methods of providing same

(76) Inventors: Joseph L. Torres, Kissimmee, FL (US); Rafael Jiminez, Kissimmee, FL (US)

Correspondence Address: JEFFREY S. WHITTLE, Allen, Dyer, Doppelt, Milbrath & Gilchrist, P.A., 255 S. Orange Avenue, Suite 1401, P.O. Box 3791, Orlando, FL, 32802-3791, US

(21) Appl. No.: 09/774,393

(22) Filed: Jan. 31, 2001

(51) Int. Cl. G06F 17/60; G06K 5/00

(52) U.S. Cl. 705/2; 705/3; 705/4; 235/380

(57) ABSTRACT

The present invention provides a prepaid healthcare system including a plurality of prepaid healthcare consultations taking place between a plurality of patients and a plurality of physicians participating in a network of physicians. The present invention also includes a plurality of prepaid healthcare patient identifiers for identifying one of a plurality of patients as a member in the prepaid healthcare service system. The identifiers also have a plurality of prepaid healthcare consultations associated therewith. The present invention also includes a method of providing a prepaid healthcare system including distributing a plurality of patient identifiers to a plurality of patients, identifying at least one physician in a network of physicians to provide the prepaid healthcare consultation, and updating the prepaid healthcare patient identifier with patient and physician information.

### FIELD OF THE INVENTION

The present invention relates to the field of prepaid healthcare service systems and methods of providing the same. More particularly, the invention relates to the concept of pre-paying for a plurality of healthcare visits with a board certified physician.

### BACKGROUND OF THE INVENTION

Traditionally, the cost of healthcare services have been provided through insurance companies. A patient in need of healthcare services typically pays premiums to an insurance company that in turn provides patients with healthcare services from physicians when required. The premiums can vary depending on certain circumstances, e.g., the amount of a deductible or the type of insurance required. Once health insurance is obtained the patient can then seek the healthcare services of physicians that practice in different fields of medicine, provided that the physicians are members in a network used by the particular insurance company. Typically, the insurance company will pay the physician's fees, less the cost of a deductible or a co-payment. The insurance premiums combined with the insurance deductibles and co-payments can prove to be extremely costly.

It is also known in the art to provide a healthcare card to simplify payment clearing and accounting, as seen in Japanese Patent No. JP401031267A by Horibe titled “Medical Charge Payment System by Card.” Horibe describes a charge card for healthcare services. The card in Horibe is used to reduce the responsibilities of patients in the healthcare process, e.g., keeping appointments and remembering payment for the healthcare services provided by a physician. The card also provides the prepayment of a lump sum of funds for healthcare services, e.g., a prepaid balance of funds, and an area on the card where the patient can record hospital information and appointment information. This system is very similar to traditional medical insurance because it requires patients to prepay a lump sum of funds for an unknown amount of future healthcare service.

It is also known in the art for some internet based companies to provide individuals with possibilities of controlling their own healthcare services, instead of relying on employers to manage healthcare services for them. Some of these programs are described as “supermarkets” of physicians where patients can customize their health plans according to their needs. Healthcare providers participating in these “supermarkets” set their monthly fees so that the patients are aware of the amount they will pay for particular healthcare services on a monthly basis, depending on the services that the patient chooses. This arrangement is disadvantageous to those patients that only require basic healthcare services. The internet arrangements are complex approaches to obtaining healthcare services having predetermined pricing disclosed prior to attaining healthcare services that can vary depending on the healthcare provider. The inconsistency in pricing makes the process of obtaining healthcare services very time-consuming and complicated for patients of limited income. The arrangements found in Horibe and traditional medical insurance, as well as internet based services, are disadvantageous to persons of limited income because they can prove to be very costly, time-consuming, invasive, and complicated Due to the high cost associated with traditional health insurance, basic healthcare services are sometimes eliminated for people that cannot afford premiums, deductibles and co-payments. The premiums as well as other additional costs, e.g., deductibles and co-payments, put basic healthcare services for persons of limited income out of reach. With basic healthcare services out of reach for some people, simple illnesses and diseases that can be easily diagnosed and treated, usually go undetected.

These systems are also disadvantageous because patients are required to pay the insurance premiums regardless of whether or not the patients actually consult a physician or use the healthcare services associated with the insurance program. Some people that are in need of basic healthcare services, especially persons of limited income, sometimes find difficulty in paying the premiums, co-payments, and deductibles, required for traditional insurance, when there is no realized benefit for the money that is expended on the health insurance costs.

Other disadvantages associated with the above systems include the fact that they are lacking in simplicity. In order for a patient to obtain traditional insurance, the patient must normally complete a long and detailed application process and in some cases must also participate in a long interview process with an insurance sales associate involving personal matters. These interviews can prove to be very invasive of the patients' privacy. Further, patients wishing to update personal or medical information must usually go through a series of persons to simply update this information, i.e., the patient must go through a physician and/or an insurance company in order to update simple information, such as an address.

### SUMMARY OF THE INVENTION

With the foregoing in mind, the present invention advantageously includes a prepaid healthcare service system that provides a preselected number of healthcare consultations between a plurality of physicians and a plurality of patients participating in the prepaid healthcare service system. The plurality of physicians are certified physicians and participate in a network of physicians.

More particularly, the present invention advantageously provides a prepaid healthcare system patient identification card that includes a body formed of a flexible material. The patient identification card includes medical network indicia printed on a surface portion of the body of the card. The patient identification card further includes patient identification means for identifying information associated with at least one of a plurality of patients and prepaid healthcare consultation monitoring means for monitoring a predetermined number of prepaid healthcare consultations purchased by each of the plurality of patients, both positioned on the surface of the body of the card.

The present invention also advantageously provides a prepaid healthcare service system having a plurality of prepaid healthcare patient identifiers, and a network of physicians. The plurality of prepaid healthcare patient identifiers are positioned to identify information associated with one of the plurality of patients. Each one of the plurality of prepaid healthcare patient identifiers is associated with one patient and has a preselected number of prepaid healthcare consultations associated therewith. The network of physicians includes a plurality of physicians accepting the prepaid healthcare patient identifiers as recognition that each of the prepaid healthcare patient identifiers includes a preselected number of prepaid healthcare consultations associated therewith. The prepaid healthcare consultations take place between one of the plurality of patients and one of the plurality of physicians in the network of physicians.

This system advantageously allows the distribution of several prepaid healthcare patient identifiers to several patients. The system also advantageously allows the patients participating in the prepaid healthcare service system to obtain prepaid healthcare consultations from any one of a plurality of physicians in the network of physicians. This system, unlike traditional insurance, is advantageous because the patients will only pay for the number of healthcare consultations that are desired and used. The system does not require the patients to pay premiums for healthcare services that may or may not actually be used. The system also advantageously allows patients to take advantage of healthcare services without the need to pay any additional costs, i.e., co-payments or deductibles.

The present invention further advantageously provides a prepaid healthcare system including a server having a database. The database includes data related to a plurality of patients and a plurality of physicians in a network of physicians. The prepaid healthcare system also includes a communications network positioned to be in communication with the server, and a plurality of computers, each having a user interface responsive to the user, positioned to be in communication with the communications network. The system further includes prepaid healthcare updating means positioned on the server for updating information regarding each of the plurality of patients. The prepaid healthcare system advantageously allows each of the plurality of patients the opportunity to purchase a plurality of prepaid healthcare consultations without the hassles associated with traditional insurance, i.e., the completion of lengthy applications. As computer access is becoming readily and freely available to all persons in such places as public libraries, the present invention is even more advantageous because it allows a patient to update personal or medical information through the use of a computer having a user interface.

The present invention further advantageously includes a method of providing a prepaid healthcare service program. The method includes the step of distributing a plurality of prepaid healthcare patient identifiers having a plurality of prepaid healthcare consultations associated therewith. The plurality of prepaid healthcare consultations advantageously take place between a plurality of patients and a plurality of physicians in a network of physicians. The method also includes the step of identifying at least one of the plurality of physicians in the network of physicians to provide at least one of the plurality of prepaid healthcare consultations to at least one of the plurality of patients.

The present invention still further advantageously provides a method of selling a plurality of prepaid healthcare consultations. The method includes the step of distributing a first plurality of prepaid healthcare patient identifiers having a plurality of prepaid healthcare consultations associated therewith from a first individual physician in a network of physicians to a first plurality of physicians in the network of physicians and to a first plurality of patients. The method also includes the step of distributing a second plurality of prepaid healthcare patient identifiers from the first plurality of physicians in the network of physicians to a second plurality of physicians in the network of physicians and a second plurality of patients. The first and second plurality of patients define members in a prepaid healthcare service system.

This method is advantageous because it allows the plurality of patients participating in the prepaid healthcare service system the opportunity to purchase a plurality of prepaid healthcare consultations from several different sources, i.e., any one of a plurality of physicians that has prepaid healthcare consultations available for sale. The method is also advantageous because it increases the number of the plurality of physicians in the network of physicians. A larger number of physicians provide a large pool of physicians that are diverse in their abilities and qualifications to provide healthcare services to several patients The increased number of physicians in the network of physicians also provides patients with several options as to where to obtain the prepaid healthcare consultations.

The present invention is advantageous to those persons who provide healthcare benefits, i.e., employers, to others. For example, employers can use the present invention to supplement catastrophic healthcare insurance, thereby providing a well rounded healthcare package to each of their employees. The employees can advantageously use the present invention for basic healthcare consultations and will still be covered by catastrophic healthcare insurance provided from their employer in the event that complex and expensive medical treatment be becomes necessary

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a schematic view of a prepaid healthcare system including a plurality of patient identifiers, a plurality of patients, and a network of physicians according to the present inventions;

FIG. 2 is a schematic view of a prepaid healthcare system including a plurality of patient identifiers distributed from physicians to patients, according to the present invention;

FIG. 3 is a perspective view of a patient identifier reader in communication with a communications network according to the present invention;

FIG. 4 is a schematic view of a prepaid healthcare system including a server, a communications network, and a plurality of computers according to the present invention;

FIG. 5 is a front perspective view of a prepaid healthcare patient identification card according to the present invention;

FIG. 5A is a fragmentary front elevation view of a prepaid healthcare patient identification card according to the present invention;

FIG. 6 is a rear perspective view of a prepaid healthcare patient identification card according to the present invention;

FIG. 7 is an environmental view of a distribution device and a telephone according to the present invention;

FIG. 8 is an environmental view of a computer having a user interface positioned to be in communication with a communications network and a user according to the present invention; and

FIG. 9 is a flow chart describing the method of selling, distributing and using a plurality of prepaid healthcare consultations according to the present invention.

### DETAILED DESCRIPTION OF THE PREFERRED EMBODIMENTS

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, the prime notation, if used, indicates similar elements in alternative embodiments.

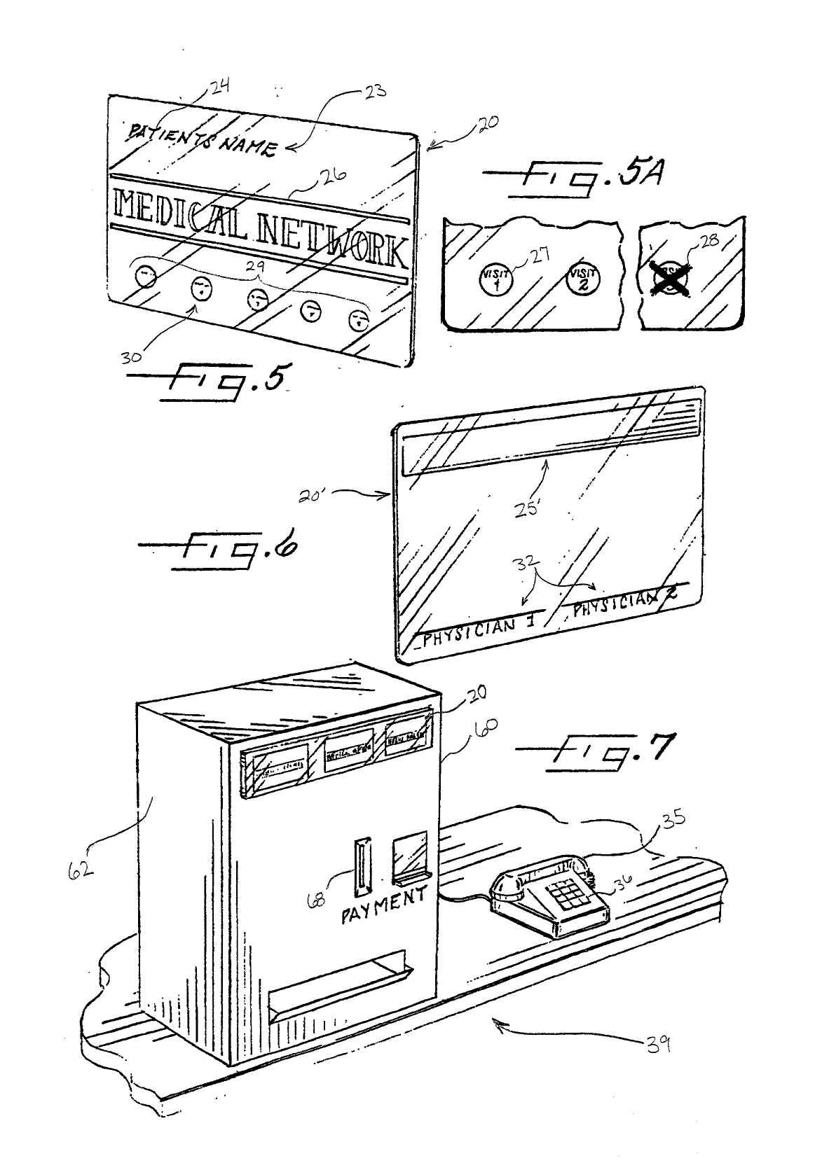

More particularly, the present invention provides a prepaid healthcare system patient identification card 22 as illustrated in FIG. 5. The card 22 preferably includes a body having any number of geometrical shapes, e.g., rectangular, square or circular. The material that forms the body of the card 22 is preferably flexible but can also be formed of a rigid material. Some flexible materials that can be used to form the card include paper, cardboard, plastic or any other material that is substantially flexible. Some rigid materials that can be used to form the body of the card 22 include hard plastics, fiberglass, or any other materials that are substantially rigid. The patient identification card 22 also advantageously includes medical network indicia 26 printed on the surface of the body of the card 22. The patient identification card 22 includes a preselected number of prepaid healthcare consultations associated therewith. The patient identification card 22 further advantageously includes patient identification means 23 and prepaid healthcare consultation monitoring means 30, both positioned on the body of the card 22. The patient identification means 23 identifies information associated with at least one of a plurality of patients 40 participating in a prepaid healthcare system 10. The prepaid healthcare consultation monitoring means 30 advantageously monitors the preselected number of prepaid healthcare consultations purchased by each of the plurality of patients 40.

In a first embodiment of the prepaid healthcare patient identification card 22, the patient identification means 23 can include indicia 24 printed on the body of the patient identification card 22. The indicia 24 is unique to each patient 40 or group of patients, i.e., a family, participating in the prepaid healthcare service system 10. The indicia 24 can include the patient's name or an identification number that is unique to each one of the plurality of patients 40. Therefore, the patient identification means 23 advantageously associates one patient 40 with one card 22. The patient identification means 23 can also advantageously associate one group of patients 40, i.e., a family, with one card 22. By associating each one of the prepaid healthcare patient identification cards 22 with each one the plurality of patients 40 the possibility of fraud is significantly decreased. In other words, by making each one of the plurality of prepaid healthcare patient identification cards 22 unique to each one of the plurality of patients 40, or group of patients, it is possible to prevent the theft and unauthorized use of prepaid healthcare patient identification cards 22. The patient identification means 23 also advantageously simplifies the task of identifying other information, i.e., personal or medical information, about each of the plurality of patients 40 by allowing the physician 50, or other healthcare representative, the opportunity to readily identify each of the patients 40 as well as medical information associated with each of the patients 40.

As also illustrated in FIG. 5, the prepaid healthcare consultation monitoring means 30 of the prepaid healthcare patient identification card 22 preferably includes a first indicium 27 and second indicium 28 positioned on the body portion of the patient identification card 22. The first indicium 27, for example, can represent at least one of the plurality of prepaid healthcare consultations. The second indicium 28 can be positioned over the first indicium 27 to thereby represent a prepaid healthcare consultation that has been used. For example, after the healthcare consultation is conducted between the patient 40 and the physician 50 the second indicium 28 is positioned over the first indicium 27 to thereby represent that the healthcare consultation represented by the first indicium 27 has been used. This configuration of the prepaid healthcare consultation monitoring means 30 advantageously allows each of the plurality of patients 40 the opportunity to monitor the number of prepaid healthcare consultations remaining from the initial number of prepaid healthcare consultations initially purchased.

In a second embodiment, the prepaid healthcare system patient identification card 22′ can also advantageously include data storage capacity 25′. The data storage capacity 25′ can advantageously include a magnetic strip, for example, positioned on a body portion of the patient identification card 22′ as illustrated in FIG. 5, or any storage medium upon which various forms of data can be stored. The patient identification means 23′ and the prepaid healthcare consultation monitoring means 30′ can advantageously be positioned on the data storage capacity 25′ of the patient identification card 22′. This advantageously eliminates the need to position multiple indicium throughout the body of the card 22′ to accomplish the same tasks of identifying and monitoring patient information and the number of prepaid healthcare consultations. This also advantageously allows each of the plurality of patients 40 and each of the plurality of physicians 50 in the network of physicians 56 a fast and simplified way of updating and monitoring patient information.

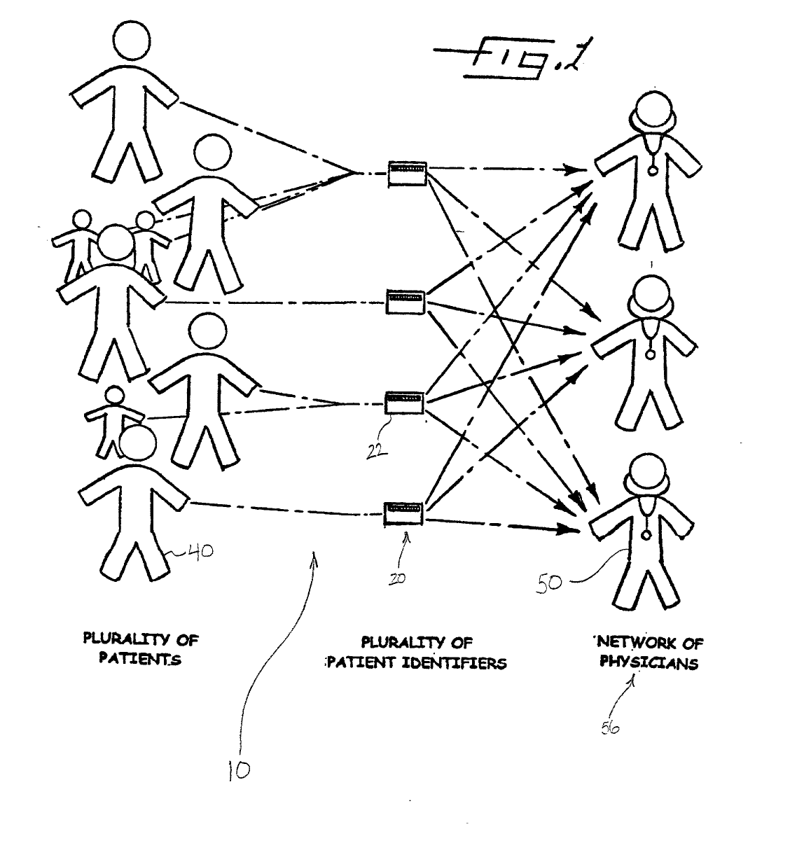

Referring to FIG. 1, the present invention also provides a prepaid healthcare service system 10 having a plurality of prepaid healthcare patient identifiers 20 positioned to identify information associated with one of a plurality of patients 40. Each one of the plurality of prepaid healthcare patient identifiers 20 preferably includes a preselected number of prepaid healthcare consultations associated therewith, as best illustrated in FIG. 5. Each of the plurality of patients 40 can advantageously choose the preselected number of prepaid healthcare consultations as desired, and each of the plurality of prepaid healthcare patient identifiers 20 reflects the preselected number of prepaid healthcare consultations.

As also illustrated in FIG. 1, the prepaid healthcare service system preferably includes a network of physicians 56. The network of physicians 56 preferably includes a plurality of physicians 50 that accept each of the plurality of prepaid healthcare patient identifiers 20 as recognition that the patient identifiers 20 include a preselected number of prepaid healthcare consultations associated therewith. The prepaid healthcare consultations take place between one of a plurality of patients 40 and one of the plurality of physicians 50 in the network of physicians 56.

The network of physicians 56 preferably includes a plurality of physicians 50 in many different geographical locations and practicing in many different fields of medicine. This arrangement of the network of physicians 56 advantageously allows patients 40 to obtain healthcare services in various geographical locations, thereby preventing lengthy travel. This is further advantageous because it allows patients 40 traveling away from their home area an easy way of obtaining healthcare services. Likewise, the arrangement of a network of physicians 50 also advantageously allows patients to seek the healthcare services of many different physicians 50 in a diverse field of medicine, such as general medicine, internal medicine, pediatrics, etc. Therefore, the fields of medicine in which the patients 40 can receive treatment are not limited to basic healthcare, but can also include many other fields of medical specialties.

The prepaid healthcare service system 10 of the present invention also includes patient identifier reading means 38 for reading the prepaid healthcare patient identifiers 20. The patient identifier reading means 38 are positioned at a location of each of the plurality of physicians 50 in the network of physicians 56 and identify each one of the plurality of patients 40 as being associated with the plurality of physicians 50 in the network of physicians 56. The prepaid healthcare patient identifiers 20 can advantageously be patient identification cards 22 having a body, and the patient identifier reading means 38 can include patient identification card readers 71. The patient identification card readers 71 can advantageously identify the patient identification card 22 and associate the patient identification card 22 with the patient 40. The patient identification card reader 71 can also identify other information positioned on the patient identification card 22, such as patient medical history.

The prepaid healthcare service system 10 of the present invention also advantageously includes tracking means 29 for tracking the preselected number of prepaid healthcare consultations associated with each of the plurality of prepaid healthcare patient identifiers 20. The tracking means 29 can be positioned on the body portion of the patient identification card 22. The tracking means advantageously includes a tracker positioned to track the number of prepaid healthcare consultations originally purchased by each of the plurality of patients 40 participating in the prepaid healthcare service system 10.

The prepaid healthcare service system 10 still further advantageously includes updating means 32 for updating information regarding each of the plurality of patients 40 and each of the plurality of physicians 50 in the network of physicians 56. The updating means 32 can be positioned on the surface of the body of the patient identification card 22. The updating means 32 advantageously allows patients 50 to update personal information, i.e., address, telephone number, and personal medical history information. The updating means 32 also advantageously allows physicians 50 to update medical information regarding each of the plurality of patients 40. For example, when one of the plurality of patients 40 consults one of the plurality of physicians 50 in the network of physicians 56, the physician 50 can advantageously view past medical information regarding the patient 40 and update the medical information according to the present healthcare consultation. The updating means 32 can further advantageously be used to update information about each of the plurality of the physicians 50. If, for example, a physician 50 changes locations, this information can easily be changed using the updating means 32. Further, if additional physicians 50 join the network of physicians 56, information regarding the network of physicians 56, e.g., locations and medical specialty, can also be updated using the updating means 32.

The prepaid healthcare service system 10 further includes distributing means 39 for distributing the plurality of prepaid healthcare patient identifiers 20 to the plurality of patients 40. The distributing means 39 can advantageously include a healthcare representative that distributes the plurality of patient identifiers 20 to the plurality of patients 40. The healthcare representative can be one of the plurality of physicians 50 in the network of physicians 56 or can also advantageously include a prepaid healthcare patient identifier sales representative. The sales representative can advantageously concentrate on distributing the prepaid healthcare patient identifiers 20 to the plurality of patients 40 that chose to participate in the prepaid healthcare service system 10 so as to allow the plurality of physicians 50 in the network of physicians 56 to better utilize their time in treating the plurality of patients 40.

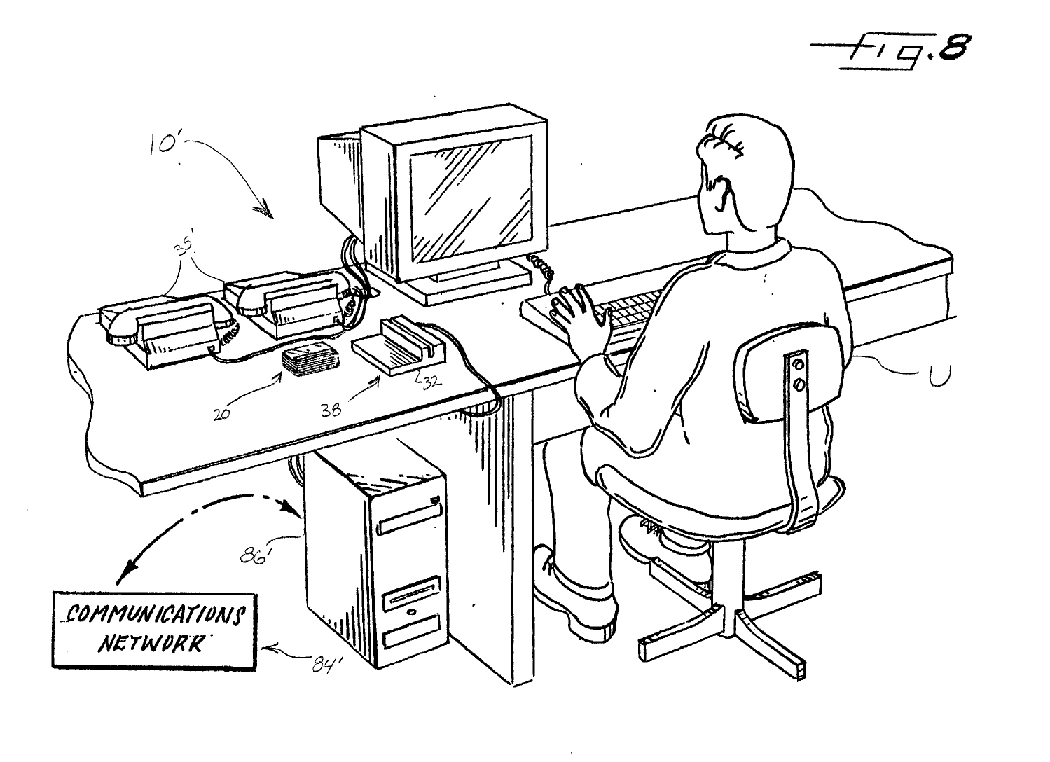

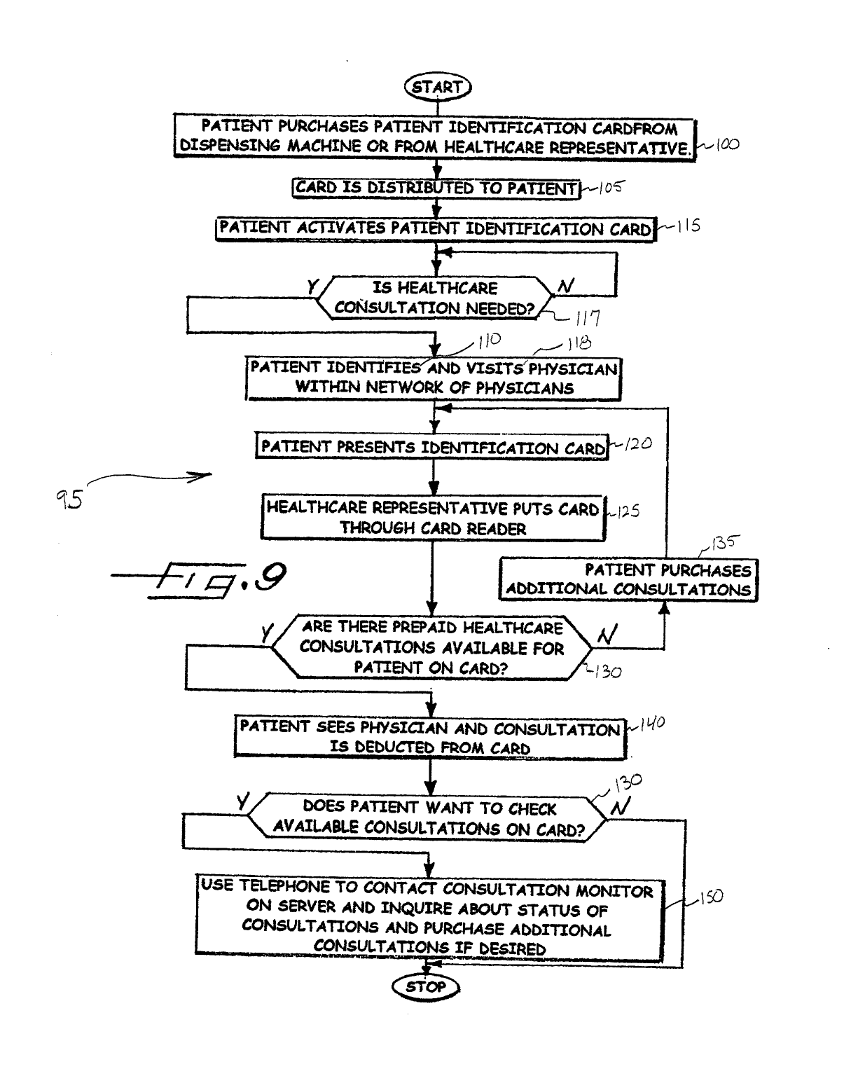

As illustrated in FIG. 7, the distributing means 39 can include a distribution device 60 having an outer surface portion 62. The distribution device can advantageously be positioned in a public location, e.g., a convenience store, grocery store, or public library and can also be positioned at the location of each of the plurality of physicians 50 in the network of physicians 56. The distribution device 60 can be characterized as a vending machine as understood by those skilled in the art. The distribution device 60 includes purchasing means 64 for purchasing at least one of the plurality of prepaid healthcare patient identifiers 20 positioned therein. The purchasing means 64 includes a payment device 68. The payment device 68 can include a device that recognizes currency, such as dollar bills and coins for example, and can also include a device that is responsive to credit and debit cards for payment of at least one prepaid healthcare patient identifier 20. Once the payment device 68 accepts a predetermined payment as recognition for payment for the at least one prepaid healthcare patient identifier 20, the distribution device 60 dispenses the at least one prepaid healthcare patient identifier 20.

The prepaid healthcare service system 10 further includes prepaid healthcare patient identifier activating means 39 for activating each of the plurality of prepaid healthcare patient identifiers 20. As illustrated in FIG. 7, the activating means 34 can advantageously include a telephone 35. When one of the plurality of patients 40 purchases one of the plurality of prepaid healthcare patient identifiers 20, the patient 40 can use the telephone 35 to contact a healthcare representative. The healthcare representative can then verify that the prepaid healthcare patient identifier 20 in the possession of the patient 40 is valid. Upon a determination of validity, the healthcare representative can then activate the prepaid healthcare patient identifier 20.

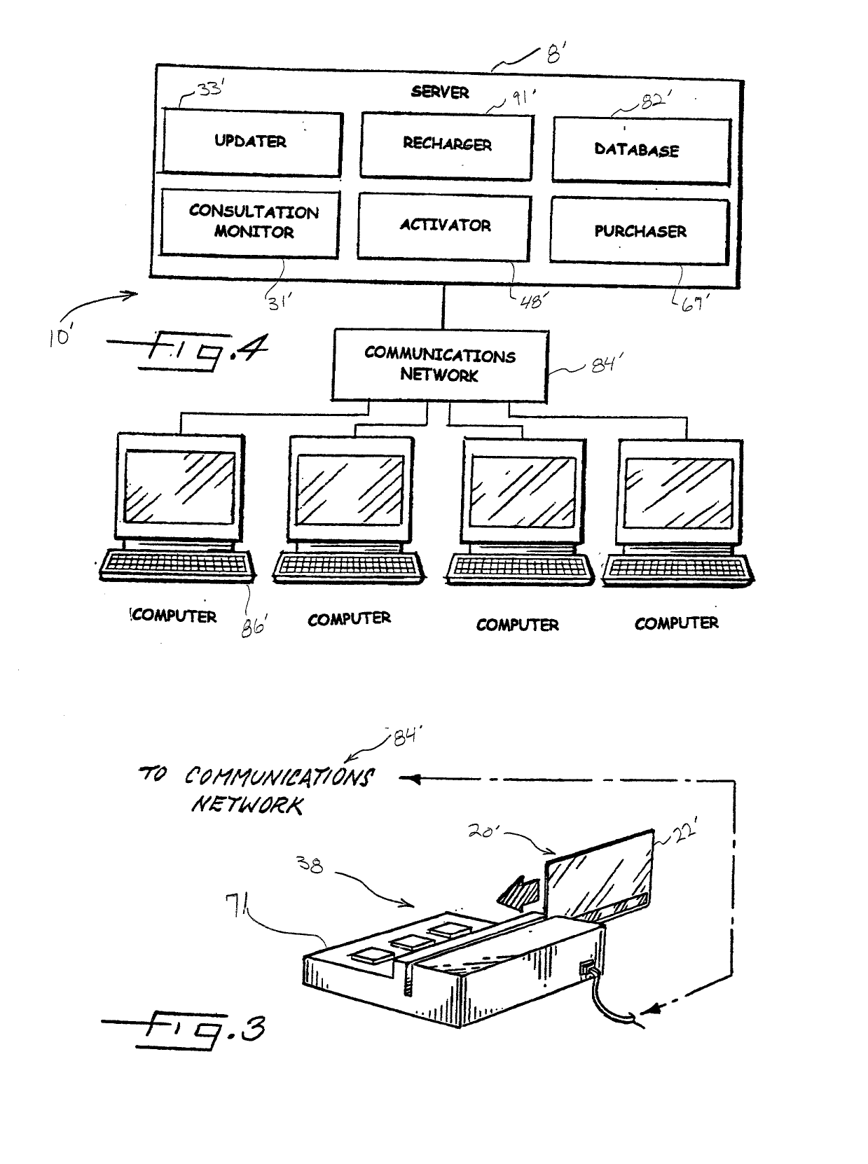

As best illustrated in FIG. 4, a second embodiment of the present invention provides a prepaid healthcare service system 10′ including a server 80′ having a database 82′ including data related to a plurality of patients 40 and a plurality of physicians 50 in a network of physicians 56. The prepaid healthcare service system 10′ also advantageously includes a communications network 84′ positioned to be in communication with the server 80′. The prepaid healthcare service system further includes a plurality of computers 86′ positioned to be in communication with the communications network 84′ including a user interface responsive to a user U. The system still further includes purchasing means 64′ for purchasing a plurality of prepaid healthcare consultations with the plurality of physicians 50 in the network of physicians 56 and prepaid healthcare updating means 32′ for updating information regarding each of the plurality of patients 40. Both the updating means 32′ and the purchasing means 64′ are positioned on the server 80′.

The updating means 32′ includes an updater 33′ that can advantageously update the names and locations of the plurality of physicians 50 in the network of physicians 56 and the names and locations of new physicians joining the network of physicians 56. A physician 50, for example, that has recently relocated can easily access the updater 33′ positioned on the server 80′ through a computer that is in communication with the server 80′. The updater 33′ is also advantageous because it allows new physicians that join the network of physicians 56 to post the locations where prepaid healthcare consultations can be obtained. The updater 33′ still further advantageously allows patients 40 to update personal information, i.e, address and telephone number, in a manner that is not time-consuming or complicated. The patient 40 can simply access the updater 33′ positioned on the server 80′ through the use of a computer 86′ that is positioned to be in communication with the communications network 84′. Computers 86′ that are positioned to be in communication with the communications network 84′ are advantageously located in a variety of public locations, e.g., public libraries, where any person can easily use the computer 86′. These computers 86′ are normally provided for use to persons in the community free of charge. This system is very advantageous because computer 86′ that are positioned to be in communication with a communications network 84′ are available for persons to use in many public locations.

The purchasing means 64′ positioned on the server 80′ can advantageously include a purchaser 67′. A patient 40 or user U that accesses the server 80′ through one of the plurality of computers 86′ positioned to be in communication with the communications network 84′, can advantageously purchase a plurality of prepaid healthcare patient identifiers 20′ using the purchaser 64′. Each of the plurality of prepaid healthcare patient identifiers 20′ includes a preselected number of prepaid healthcare consultations associated therewith. Each one of the prepaid healthcare patient identifiers 20′ can include a card 22′ having a flexible body. Each of the plurality of cards 22′ includes patient identification means 23′ positioned on a surface of the flexible body of the card 22′ that can advantageously be used to identify each of the plurality of patients 40 participating in the prepaid healthcare service system 10′ Each of the plurality of cards 22′. also includes medical network identification means 37′ positioned on the flexible body for identifying the network of physicians 56 providing the plurality of prepaid healthcare consultations to the plurality of patients 40. The patient identification means 23′ positioned on each of the plurality of patient identification cards 22′ advantageously makes each of the plurality of cards 22′ unique to each of the plurality of patients 40. Further, the patient identification means 23′ advantageously simplifies the process for each of the physicians 50 in the network of physicians 56 to identify each of the plurality of patients 40 as being members in the prepaid healthcare service system 10′.

The prepaid healthcare service system further includes monitoring means 30′ positioned on the server 80′ and responsive to the plurality of patients 40 and the plurality of physicians 50 in the network of physicians 56 for monitoring the plurality of prepaid healthcare consultations purchased by each of the plurality of patients 40. The monitoring means 30′ advantageously includes a consultation monitor 31′, as perhaps best illustrated in FIG. 4, for tracking the remaining number of the plurality of prepaid healthcare consultations. The consultation monitor 31′ also advantageously informs each of the plurality of patients 40 when the remaining number of the plurality of prepaid healthcare consultations is equal to or less than the predetermined number. For example, if the predetermined number is one, then the consultation monitor 31′ will inform the patient when the remaining number of prepaid healthcare consultations is equal to or less then one. This advantageously prevents a situation where one of the plurality of patients 40 suddenly does not have enough prepaid healthcare consultations associated with the prepaid healthcare patient identifier 20′, and further eliminates a lack of warning as to when each of the plurality of patients 40 should purchase additional prepaid healthcare consultations.

The prepaid healthcare service system further includes recharging means 90′ positioned on the server 80′ and responsive to each of the plurality of patients 40 and each of the plurality of physicians 50 in the network of physicians 56. The recharging means 90′ includes a recharger 91′, as perhaps best illustrated in FIG. 4, for purchasing additional prepaid healthcare consultations. When each of the plurality of patients 40 are informed that the remaining number of prepaid healthcare consultations is equal to or less than the predetermined number, the recharger 91′ advantageously allows each of the plurality of patients 40 an avenue to recharge or replenish the amount of prepaid healthcare consultations associated with the patient identifier 20′ without the need to purchase a new patient identifier 20′. This also advantageously reduces the waste associated with providing additional patient identifiers 20′ every time the patients 40 purchase additional prepaid healthcare consultations. The recharger 91′ can also advantageously be configured to automatically replenish the number of prepaid healthcare consultations when the remaining number of prepaid healthcare consultations is equal to or less than the predetermined number. This advantageously eliminates some of the burden on the patient to purchase additional prepaid healthcare consultations.

The prepaid healthcare service system 10 still further includes prepaid healthcare patient identifier activating means 34′ positioned on the server 80′ and responsive to each of the plurality of patients 40 and each of the plurality of physicians 50 in the network of physicians 56. The activating means 34 can advantageously be an activator 48′, as perhaps best illustrated in FIG. 4, for activating each of the plurality of prepaid healthcare patient identifiers 20′. The activator 48′ is advantageously a simple way for each of the plurality of patients 40 and each of the plurality of physicians 50 to activate each of the plurality of patient identifiers 20′ having the preselected number of prepaid healthcare consultations associated therewith.

The prepaid healthcare service system can also advantageously include a plurality of telephones 35′ positioned to be in communication with the communications network 34′. Each of the plurality of patients 40 can use a predetermined combination of numbers 36′ on each of the plurality of telephones 35′ to access the database 82′ on the server 80′ to thereby perform various functions, such as activate patient identifiers 20′, recharge prepaid healthcare consultations, update patient information, or any other number of functions. This advantageously allows patients 40 and physicians 50 that may not have access to a computer 86′ to still participate in the prepaid healthcare service system 10′ regardless of whether or not access to a computer 86′ is available. For example, one may use a cellular telephone, or any other type of wireless communicator, to communicate with the server 80′ and thereby perform any number of a variety of functions of the prepaid healthcare service system 10′.

As illustrated in FIG. 9, the present invention also advantageously includes methods of providing 95 a prepaid healthcare service system 10. The method includes the step of purchasing 100 a prepaid healthcare patient identifier 20. The method also includes the step of distributing 105 a plurality of prepaid healthcare patient identifiers 20 having a preselected number of prepaid healthcare consultations associated therewith to a plurality of patients 40. The prepaid healthcare consultations take place between one of a plurality of physicians 50 in a network of physicians 56 and one of the plurality of patients 40. After the patient 40 purchases and receives the patient identifier 20, the patient activates 115 the patient identifier 20. The step of activating 115 the patient identifier 20 requires a verification process to determine if each of the plurality of patient identifiers 20 are valid. After the step of activating 115 the patient identifier 20 is completed, the patient 40 determines whether healthcare services are necessary 117. If the patient 40 determines that healthcare services are necessary 117, the patient 40 proceeds to the step of identifying 110 at least one of the plurality of physicians 50 in the network of physicians 56 to provide at least one of the plurality of prepaid healthcare consultations to one of the plurality of patients 40. After the patient 40 identifies the physician 50 in the network of physicians 56, the patient visits 118 the physician 50, and presents 120 the patient identifier 20 to thereby obtain a healthcare consultation. The method of distributing patient identifiers to each of the plurality of patients 40 advantageously allows each of the plurality of physicians 50 in the network of physicians 56 to identify each of the plurality of patients 40 as members in the prepaid healthcare service system 10.

The method of providing the prepaid healthcare service system 10 also includes the step of reading 125 each one of the plurality of patient identifiers 20 using a patient identifier reader 71, as illustrated in FIG. 3. The step of reading 125 can be accomplished through the use of an electronic reader that recognizes the patient identifier 20 as representing the preselected number of prepaid healthcare consultations associated with the patient identifier 20. The method further includes the step of tracking 130 the plurality of prepaid healthcare consultations associated with the patient identifiers 20, informing each of the plurality of patients when the remaining number of prepaid healthcare consultations is equal to or less than a predetermined number, and recharging 135 the number of prepaid healthcare consultations associated with each of the plurality of prepaid healthcare patient identifiers 20. This advantageously prevents the situation where the patient 40, without warning, does not have any prepaid healthcare consultations remaining associated with the prepaid healthcare patient identifier 20. This also advantageously allows patients 40 to easily purchase additional prepaid healthcare consultations as needed.

The method of providing 95 the prepaid healthcare service system 10 also includes the step of updating information on each of the plurality of patients 40 and each of the plurality of physicians 50 in the network of physicians 56. The patient information that can advantageously be updated includes personal information, such as the patient's name and address, and medical information regarding the patient's medical history and the physicians that the patient has consulted, for example. This advantageously decreases the burden on physicians to transfer medical history information from office to office. This also advantageously gives each of the plurality of patients 40 control over their private medical records. The step of updating can also advantageously allow physicians 50 to update information regarding their locations. The step of updating can still further advantageously allow new physicians joining in the network of physicians 56 to update information regarding location and field of practice.

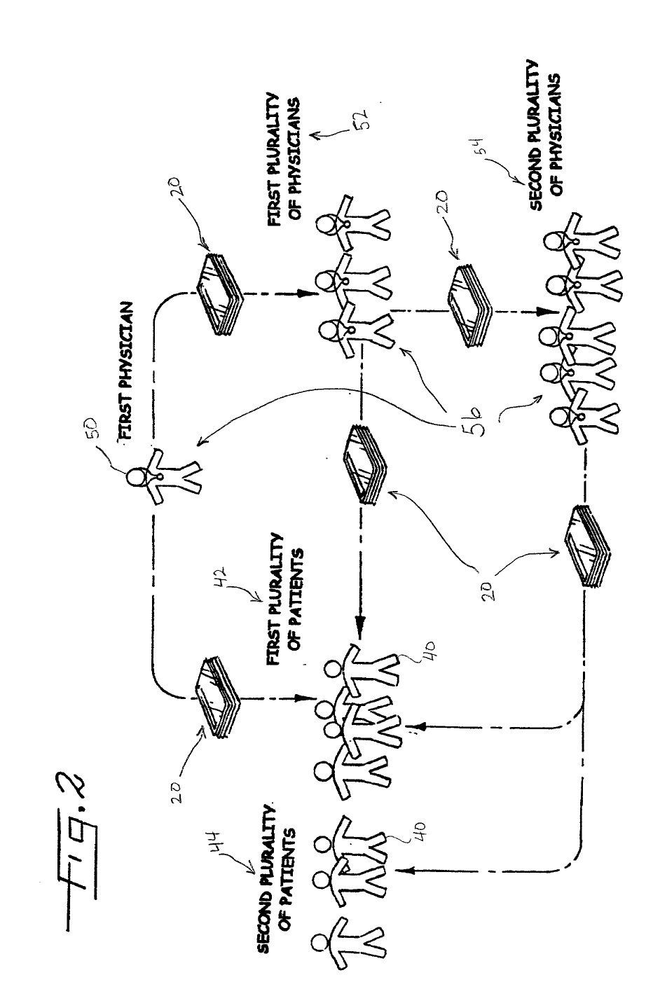

As best illustrated in FIG. 2, the present invention also includes a method of selling a plurality of prepaid healthcare consultations The method includes the step of distributing a first plurality 15 of prepaid healthcare patient identifiers 20 having a plurality of prepaid healthcare consultations associated therewith from a first individual physician 50 in a network of physicians 56 to a first plurality of physicians 52 in the network of physicians 56 and a first plurality of patients 42. The method further includes the step of distributing a second plurality 17 of prepaid healthcare patient identifiers 20 to a second plurality of physicians 54 in the network of physicians 56 and a second plurality of patients 44. The first and second plurality of patients 40 define members in a prepaid healthcare service system 10. The method of selling the prepaid healthcare consultations also includes selecting at least one of the plurality of physicians 50 from the network of physicians 56 to provide the prepaid healthcare consultations to at least one of the plurality of patients 40 in the prepaid healthcare service system 10. The method of selling the plurality of prepaid healthcare consultations to the plurality of patients 40 by distributing the plurality of patient identifiers 20 through many different physicians 50 advantageously allows patients 40 the opportunity to obtain the prepaid healthcare consultations from a variety of physicians practicing in a variety of medical fields and located in a variety of geographical locations.

The present invention still further includes a method of providing a plurality of prepaid healthcare consultations. The method includes the steps of purchasing a prepaid healthcare patient identifier 20 having a plurality of prepaid healthcare consultations associated therewith. The method still further includes the step of distributing the prepaid healthcare identifier 20 to a plurality of patients 40. The method of providing the plurality of prepaid healthcare consultations also includes the step of monitoring 130 a remaining number of the plurality of prepaid healthcare consultations and further including the step of informing each of the plurality of patients 40 when the remaining number of the plurality of prepaid healthcare consultations is equal to or less than a predetermined number. In the event that the patient 40 finds that the remaining number of prepaid healthcare consultations is lower than desired, the method of providing prepaid healthcare consultations also includes the step of recharging 135 the prepaid healthcare consultations. Each of the plurality of patients 40 can recharge or replenish the number of prepaid healthcare consultations by purchasing additional prepaid healthcare consultations from a healthcare representative or a physician 50 in the network of physicians 56. This method advantageously allows a patient to monitor the status of the number of prepaid healthcare consultations remaining and insure that the patient 40 will not suddenly be left without any prepaid healthcare consultations.

The method of providing the plurality of prepaid healthcare consultations also advantageously includes the step of selecting 110 at least one physician 50 in the network of physicians 56 to provide the at least one of the prepaid healthcare consultations to at least one of the plurality of patients 40. The step of selecting 110 at least one of the plurality of physicians 50 advantageously allows each of the plurality of patients 40 to customize their healthcare needs. For example, the patient 40 may select one of the plurality of physicians 50 depending on the medical needs, e.g., pediatrician, cardiologist, optometrist, etc. The step of selecting 110 one of the plurality of physicians 50 is also advantageous because it further allows each of the plurality of patients 40 to select a physician 50 that is convenient in location. This prevents patients that are already in need of healthcare services from traveling further than necessary to obtain healthcare services.

As illustrated in FIG. 4, a second embodiment of the present invention advantageously includes a method of providing a plurality of prepaid healthcare consultations including the step of connecting a computer 86′ having a user interface to a communications network 84′ that is positioned to be in communication with a server 30′. The method of providing a plurality of prepaid healthcare consultations also includes the steps of purchasing a plurality of prepaid healthcare patient identifiers 20′ and locating one of a plurality of physicians 50 in a network of physicians 56 using information found on a database 82′. The database 82′ includes information regarding each of the plurality of physicians 50 including location and the field of medicine in which the physician 50 practices. This advantageously allows each of the plurality of patients 40 participating in the prepaid healthcare service system to easily locate one of the plurality of physicians 50 in the network of physicians 56 that suits their needs.

The method of providing the plurality of prepaid healthcare consultations further includes the step of updating the database 82′ on the server 80′ with information regarding the network of physicians 56 and the plurality of patients 40. The step of updating is accomplished by accessing an updater 33′ positioned on the server 80′ through the computer 86′ positioned to be in communication with the communications network 84′. The updater 33′ is responsive to the plurality of patients 40 and the plurality of physicians 50 in the network of physicians 56. Further, each of the plurality of patients 40 can advantageously update personal as well as medical information on the updater 33′. Still further, each of the plurality of physicians 50 can update medical information regarding each of the plurality of patients 40 and also information regarding the locations of each of the plurality of physicians 50. New physicians entering the network of physicians 56 can advantageously update information upon entrance into the network of physicians 56. This advantageously allows each of the plurality of physicians 50 in the network of physicians 56 to be readily visible to each of the plurality of patients 40. In other words, patients 40 will not have difficulty in finding one of the plurality of physicians 50 in the network of physicians 56 as the information concerning their location and field of practice is easily updated on the database 82′ by each of the plurality of physicians 50. This is also advantageous to each of the plurality of patients 40 because when the physicians 50 update location and practice information, the process of locating a physician 50 in the network of physicians 56 is simplified.

The method of providing a plurality of prepaid healthcare consultations still further includes the step of activating each of the plurality of prepaid healthcare patient identifiers 20′ by accessing the database 82′ and verifying that each of the plurality of prepaid healthcare patient identifiers 20′ is valid. This can advantageously be accomplished by encoding each of the plurality of prepaid healthcare patient identifiers 20′ with a unique code before each of the plurality of patient identifiers 20′ are distributed to each of the plurality of patients 40. A copy of the unique codes are also positioned on an activator 48′ positioned on the server 86′. Each of the plurality of patients 40 and each of the plurality of physicians 50 in the network of physicians 56 access the activator 49′ through the communications network 84′ and communicate to the activator 48′ the unique code associated with the patient identifier 20′ that is in their possession. The activator 48′ then recognizes the inputted code as either being a code within the database 82′ or not. If the activator 48′ recognizes the code as being within the database 82′, the patient identifier 20′ is activated. If, however, the activator 48′ does not recognize the code as being within the database 82′, the patient identifier 20′ is not activated.

The plurality of patients 40 and the plurality of physicians 50 in the network of physicians 56 can advantageously access the activator 48′ through a computer 86′ positioned in communication with the communications network 84′. When accessing the activator using a computer 86′, each of the plurality of patients 40 or each of the plurality of physicians 50 in the network of physicians 56 can advantageously enter the unique code found on each of the plurality of patient identifiers 20′ to thereby verify that each of the plurality of patient identifiers 20′ is valid. The plurality of patients 40 and the plurality of physicians 50 in the network of physicians 56 can also advantageously access the activator 48′ using a telephone 35′ positioned to be in communication with the communications network 84′. A predetermined combination of numbers 36′ on the telephone 35′ can be entered to access the activator 48′. When the activator 48′ is accessed using the telephone 35′, the unique code can then be entered to verify if the prepaid healthcare patient identifier 20′ is valid.

The method of providing the plurality of prepaid healthcare consultations still further includes the step of recharging 135 at least one of the plurality of prepaid healthcare patient identifiers 20′ by purchasing additional prepaid healthcare consultations. The step of recharging 115 advantageously allows each of the plurality of patients 40 to purchase additional prepaid healthcare consultations independently of a sales person or a healthcare representative. This also advantageously provides each of the plurality of patients 40 the freedom to purchase as many or as few prepaid healthcare consultations as desired. The method further advantageously allows each of the plurality of patients the opportunity to purchase additional prepaid healthcare consultations when necessary, regardless of the present number of prepaid healthcare consultations remaining. For example, if the patient only gets paid once a month and, as a precaution, desires to purchase the prepaid healthcare consultations, regardless of the present need, the patient is free to do so by accessing the recharger 91′ positioned on the server 80′ and purchasing additional prepaid healthcare consultations. Each of the plurality of patients 40 and each of the plurality of physicians 50 can also advantageously access the recharger 91′ positioned on the server using a telephone 35′ that is positioned in communication with the communications network 84′. This advantageously eliminates the need for a computer 86′. The technology available in wireless communication, i.e., cellular telephones, provide each of the plurality of patients 40 and each of the plurality of physicians 50 in the network of physicians 56 access to the recharger 91′ wherever telephone service or wireless communication service is available.

The present invention is advantageous to those persons who provide healthcare benefits, i.e., employers, to others. For example, employers can use the present invention to supplement catastrophic healthcare insurance, thereby providing a well rounded healthcare package to each of their employees. The employees can advantageously use the present invention for basic healthcare consultations and will still be covered by catastrophic healthcare insurance provided from their employer in the event that complex and expensive medical treatment be becomes necessary. The present invention is also advantageous to those persons who do not have health insurance or who work in positions that do not provide health insurance. Traditional health insurance proves to be extremely costly to these persons, and therefore, the present invention makes basic healthcare services available to them.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That claimed is:

1. A prepaid healthcare system patient identification card comprising:
a body having a substantially rectangular shape formed of a flexible material;
medical network indicia printed on a surface portion of the body of the prepaid healthcare system patient identification card;
patient identification means positioned on the surface of the body of the prepaid healthcare system patient identification card for identifying information associated with at least one of a plurality of patients; and
prepaid healthcare consultation monitoring means positioned on the surface of the body of the prepaid healthcare system patient identification card for monitoring a preselected number of prepaid healthcare consultations purchased by each of the plurality of patients.

2. The prepaid healthcare system patient identification card as described in claim 1, wherein the patient identification means further comprises indicia, the indicia being unique to each one of the plurality of patients.

3. The prepaid healthcare system patient identification card as described in claim 1, wherein the prepaid healthcare consultation monitoring means further comprises a first at least one indicium representing at least one prepaid healthcare consultation.

4. The prepaid healthcare system patient identification card as described in claim 3, wherein the prepaid healthcare consultation monitoring means further comprises a second at least one indicium positioned over the first at least one indicium, the second at least one indicium representing a used prepaid healthcare consultation.

5. The prepaid healthcare system patient identification card as described in claim 1, further comprising data storage capacity positioned on the body of the prepaid healthcare system patient identification card, the data storage capacity including the patient identification means and the prepaid healthcare consultation monitoring means.

6. A prepaid healthcare system patient identification card comprising:
a body formed of a flexible material;
patient identification means positioned on a surface portion of the body for identifying information associated with one of a plurality of patients, each one of the plurality of patients participating in a network of physicians, the network of physicians comprising a plurality of physicians providing a preselected number of prepaid healthcare consultations to each of the plurality of patients; and
prepaid healthcare consultation monitoring means positioned on the surface portion of the body for monitoring the preselected number of prepaid healthcare consultations purchased by one of the plurality of patients.

7. The prepaid healthcare system patient identification card as described in claim 6, further comprising data storage capacity positioned on the surface of the patient identification card, the data storage capacity including the patient identification means, the prepaid healthcare consultation monitoring means, and medical network identification means for identifying the medical network associated with the plurality of physicians in the network of physicians providing the preselected number of prepaid healthcare consultations.

8. The prepaid healthcare system patient identification card as described in claim 6, wherein the patient identification means further comprises unique information regarding each the plurality of the patients.

9. The prepaid healthcare system patient identification card as described in claim 6, further comprising updating means positioned on the surface of the body for updating information regarding each of the plurality of patients and each of the plurality of physicians participating in the network of physicians.

10. A prepaid healthcare service system comprising:
a plurality of prepaid healthcare patient identifiers positioned to identify information associated with one of a plurality of patients, each one of the plurality of prepaid healthcare patient identifiers associated with one patient and having a preselected number of prepaid healthcare consultations associated therewith; and
a network of physicians comprising a plurality of physicians accepting the plurality of prepaid healthcare patient identifiers as recognition that each of the prepaid healthcare patient identifiers includes a preselected number of prepaid healthcare consultations associated therewith taking place between one of the plurality of patients and one of the plurality of physicians in the network of physicians.

11. The prepaid healthcare service system as described in claim 10, further comprising patient identifier reading means positioned at a location of each of the plurality of physicians in the network of physicians for reading the prepaid healthcare patient identifiers to thereby identify each one of the plurality of patients as being associated with the plurality of physicians in the network of physicians providing a preselected number of prepaid healthcare consultations to each one of the plurality of patients.

12. The prepaid healthcare service system as described in claim 11, wherein each of the plurality of prepaid healthcare patient identifiers further comprises a card having a flexible body and having indicia positioned on a surface portion of the flexible body for identifying a medical network associated with the plurality of physicians in the network of physicians.

13. The prepaid healthcare service system as described in claim 12, further comprising tracking means positioned on the surface of the body of the card for tracking the preselected number of prepaid healthcare consultations associated with each of the plurality of prepaid healthcare patient identifiers.

14. The prepaid healthcare service system as described in claim 13, further comprising updating means positioned on the surface of the body of the card for updating information regarding each of the plurality of patients and each of the plurality of physicians in the network of physicians.

15. The prepaid healthcare service system as described in claim 14, further comprising distributing means for distributing the plurality of prepaid healthcare patient identifiers to the plurality of patients.

16. The prepaid healthcare service system as described in claim 15, wherein the distributing means further comprises a distribution device having an outer surface portion and positioned in a public location and comprising the plurality of prepaid healthcare patient identifiers positioned therein, and further comprising purchasing means positioned adjacent the outer surface for purchasing the plurality of prepaid healthcare patient identifiers.

17. The prepaid healthcare service system as described in claim 16, wherein the purchasing means further comprises a payment device that accepts a predetermined payment for each of the plurality of prepaid healthcare patient identifiers, and wherein upon recognition of the payment, the distribution device dispenses one of the plurality of prepaid healthcare patient identifiers.

18. The prepaid healthcare service system as described in claim 17, further comprising prepaid healthcare patient identifier activating means for activating each of the plurality of prepaid healthcare patient identifiers dispensed from the distribution device.

19. The prepaid healthcare service system as described in claim 18, wherein the activating means further comprises a telephone, wherein one of the plurality of patients that purchases one of the plurality of prepaid healthcare patient identifiers uses the telephone to contact a healthcare representative, and wherein the healthcare representative activates the prepaid healthcare patient identifier.

20. A prepaid healthcare service system, comprising:
a server having a database including data related to a plurality of patients and a plurality of physicians in a network of physicians;
a communications network positioned to be in communication with the server;
a plurality of computers positioned to be in communication with the communications network and including a user interface responsive to a user;
purchasing means positioned on the server and responsive to the plurality of patients and the plurality of physicians in the network of physicians for purchasing a plurality of prepaid healthcare consultations with the plurality of physicians in the network of physicians; and
prepaid healthcare updating means positioned on the server for updating information regarding each of the plurality of patients.

21. The prepaid healthcare service system as defined in claim 20, wherein the prepaid healthcare updating means further updates names and locations of the plurality of physicians in the network of physicians and the names and locations of new physicians joining the network of physicians.

22. The prepaid healthcare service system as described in claim 21, further comprising a plurality of prepaid healthcare patient identifiers having the plurality of prepaid healthcare consultations associated therewith.

23. The prepaid healthcare service system as described in claim 22, wherein each of the plurality of prepaid healthcare patient identifiers further comprises a patient identification card having a flexible body.

24. The prepaid healthcare service system as described in claim 23, wherein each of the plurality of patient identification cards includes patient identification means positioned on the flexible body used for identifying information associated with each of the plurality of patients.

25. The prepaid healthcare service system as described in claim 24, wherein each of the plurality of patient identification cards includes medical network identification means positioned on the flexible body for identifying the network of physicians providing the plurality of prepaid healthcare consultations to the plurality of patients.

26. The prepaid healthcare service system as described in claim 25, further comprising prepaid healthcare consultation monitoring means positioned on the server and responsive to the plurality of patients and the plurality of physicians in the network of physicians for monitoring the plurality of prepaid healthcare consultations purchased by the plurality of patients.

27. The prepaid healthcare service system as described in claim 26, wherein the monitoring means further comprises a consultation monitor to monitor a remaining number of the plurality of prepaid healthcare consultations and inform each of the plurality of patients when the remaining number of the plurality of prepaid healthcare consultations is equal to or less than a predetermined number.

28. The prepaid healthcare service system as described in claim 27, further comprising recharging means positioned on the server and responsive to each of the plurality of patients and each of the plurality of physicians in the network of physicians for purchasing additional prepaid healthcare consultations.

29. The prepaid healthcare service system as described in claim 28, further comprising prepaid healthcare patient identifier activating means positioned on the server and responsive to each of the plurality of patients and each of the plurality of physicians in the network of physicians for activating each of the plurality of prepaid healthcare patient identifiers.

30. The prepaid healthcare service system as described in claim 29, further comprising a plurality of telephones positioned in communication with the communications network, wherein each of the plurality of patients can use a predetermined combination of numbers on each of the plurality of telephones to access the database on the server to thereby perform preselected functions.

31. A prepaid healthcare service system, comprising:
a server having a database including data related to each of a plurality of patients and a plurality of physicians in a network of physicians;
a communications network positioned to be in communication with the server;
a plurality of computers positioned to be in communication with the communications network and including a user interface responsive to a user; and
prepaid healthcare updating means positioned on the server and responsive to each of the plurality of physicians in the network of physicians for registering additional physicians in the network of physicians, and updating locations for each of the plurality of physicians in the network of physicians.

32. The prepaid healthcare service system as described in claim 31, wherein the prepaid healthcare updating means further updates information regarding each of the plurality of patients.

33. The prepaid healthcare system as described in claim 32, further comprising purchasing means positioned on the server and responsive to each of the plurality of patients and each of the plurality of physicians in the network of physicians for purchasing a plurality of prepaid healthcare consultations with the plurality of physicians in the network of physicians.

34. The prepaid healthcare service system as described in claim 33, further comprising a plurality of prepaid healthcare system patient identifiers, each of the plurality of prepaid healthcare patient identifiers having the plurality of prepaid healthcare consultations associate therewith.

35. The prepaid healthcare service system as described in claim 34, wherein each of the plurality of prepaid healthcare patient identifiers further comprises a patient identification card having a flexible body.

36. The prepaid healthcare service system as described in claim 35, wherein each of the plurality of patient identification cards includes patient identification means positioned on the flexible body used for identifying information associated with each of the plurality of patients.

37. The prepaid healthcare service system as described in claim 36, wherein each of the plurality of patient identification cards includes medical network identification means positioned on the flexible body used for identifying the network of physicians providing the plurality of prepaid healthcare consultations.

38. The prepaid healthcare service system as described in claim 37, further comprising prepaid healthcare consultation monitoring means positioned on the server and responsive to the plurality of patients and the plurality of physicians in the network of physicians for monitoring the plurality of prepaid healthcare consultations purchased by the plurality of patients.

39. The prepaid healthcare service system as described in claim 38, wherein the prepaid healthcare consultation monitoring means further comprises a tracker to track a remaining number of the plurality of prepaid healthcare consultations and inform each of the plurality of patients when the remaining number of the plurality of prepaid healthcare consultations is equal to or less than a predetermined number.

40. The prepaid healthcare service system as described in claim 39, further comprising recharging means positioned on the server and responsive to each of the plurality of patients and each of the plurality of physicians in the network of physicians for purchasing additional prepaid healthcare consultations.

41. The prepaid healthcare service system as described in claim 40, further comprising prepaid healthcare patient identifier activating means positioned on the server and responsive to each of the plurality of patients and each of the plurality of physicians in the network of physicians for activating each of the plurality of prepaid healthcare patient identifiers.

42. The prepaid healthcare service system as described in claim 41, further comprising a plurality of telephones positioned in communication with the communications network, wherein each of the plurality of patients can use a predetermined combination of numbers on each of the plurality of telephones to access the database on the server to thereby perform preselected functions.

43. A method of providing a prepaid healthcare service system, the method comprising the steps of:
distributing a plurality of prepaid healthcare patient identifiers to a plurality of patients, each of the plurality of prepaid healthcare patient identifiers identifying information associated with each of the plurality of patients and also identifying a plurality of prepaid healthcare consultations between each of the plurality of patients and a plurality of physicians in a network of physicians, the plurality of patients thereby defining a plurality of members enrolled in the prepaid healthcare service program; and
identifying at least one of the plurality of physician in the network of physicians to provide at least one of the plurality of prepaid healthcare consultations to at least one of the plurality of members enrolled in the prepaid healthcare service program.

44. The method of providing a prepaid healthcare service system as described in claim 43, further comprising the step of reading each one of the plurality of prepaid healthcare patient identifiers using a patient identifier reader positioned at a location of each one of the plurality of physicians in the network of physicians.

45. The method of providing a prepaid healthcare service system as described in claim 44, further comprising the step of tracking the plurality of prepaid healthcare consultations associated with each of the prepaid healthcare patient identifiers, the step of tracking including monitoring a remaining number of prepaid healthcare consultations and informing each of the plurality of patients when the remaining number of prepaid healthcare consultation is equal to or less than a predetermined number.

46. The method of providing a prepaid healthcare service system as described in claim 45, further comprising the step of updating information on each of the plurality of prepaid healthcare patient identifiers regarding each of the plurality of patients.

47. The method of providing a prepaid healthcare service system as described in claim 46, further comprising the step of recharging each of the plurality of prepaid healthcare patient identifiers, the step of recharging the prepaid healthcare patient identifiers including the step of purchasing additional prepaid healthcare consultations.

48. A method of selling a plurality of prepaid healthcare consultations, the method comprising the steps of:
distributing a first plurality of prepaid healthcare patient identifiers having a plurality of prepaid healthcare consultations associated therewith from a first individual physician in a network of physicians to a first plurality of physicians in the network of physicians and a first plurality of patients; and
distributing a second plurality of prepaid healthcare patient identifiers having a plurality of prepaid healthcare consultations associated therewith from the first plurality of physicians to a second plurality of physicians in the network of physicians and a second plurality of patients, the first and second plurality of patients defining members in a prepaid healthcare service system.

49. The method of selling a plurality of prepaid healthcare consultations as described in claim 48, further compromising the step of selecting at least one physician from the network of physicians for providing at least one of the plurality of prepaid healthcare consultations to at least one of the plurality of members in the prepaid healthcare service system.

50. The method of selling a plurality of prepaid healthcare consultations as described in claim 49, further compromising the step of recharging each of the plurality of prepaid healthcare identifiers by purchasing an additional plurality of prepaid healthcare consultations.

51. A method of providing a plurality of prepaid healthcare consultations, the method comprising the steps of:
purchasing at least one prepaid healthcare patient identifier having a preselected number of prepaid healthcare consultations associated therewith from a healthcare provider; and
distributing the at least one prepaid healthcare patient identifiers to a plurality of patients.

52. The method of providing a plurality of prepaid healthcare consultations as described in claim 51, further comprising the step of monitoring a remaining number of the plurality of prepaid healthcare consultations and further including the step of informing each of the plurality of patients when the remaining number of the plurality of prepaid healthcare consultations is equal to or less than a predetermined number.

53. The method of providing a plurality of prepaid healthcare consultations as described in claim 52, further comprising the step of selecting at least one of a plurality of physicians from a network of physicians to provide at least one of the plurality of prepaid healthcare consultations to at least one of the plurality of patients.

54. The method of providing a plurality of prepaid healthcare consultations as described in claim 53, further comprising recharging the at least one prepaid healthcare patient identifiers by purchasing additional prepaid healthcare consultations from a healthcare provider.

55. A method of providing a plurality of prepaid healthcare consultations, the method comprising the steps of:
connecting a computer including a user interface to a communications network that is in communication with a server having a database;
purchasing a plurality of prepaid healthcare patient identifiers, each of the plurality of prepaid healthcare patient identifiers having a plurality of prepaid healthcare consultations associated therewith; and
locating one of a plurality of physicians in a network of physicians using the database to identify a location of one of the plurality of physicians in the network of physicians.

56. The method of providing a plurality of prepaid healthcare consultations as described in claim 55, further comprising the step of updating the database with information regarding the network of physicians and a plurality of patients.

57. The method of providing a plurality of prepaid healthcare consultations as described in claim 56, further comprising the step of activating each of the plurality of prepaid healthcare patient identifiers by accessing the database and verifying that each of the plurality of prepaid healthcare patient identifiers is valid.

58. The method of providing a plurality of prepaid healthcare consultations as described in claim 57, wherein the step of activating each of the plurality of prepaid healthcare patient identifiers further includes the step of using a telephone and a predetermined combination of numbers on the telephone to access the database and verify that each of the plurality of prepaid healthcare patient identifiers is valid.

59. The method of providing a plurality of prepaid healthcare consultations as described in claim 58, further comprising recharging at least one of the plurality of prepaid healthcare patient identifiers by purchasing another plurality of prepaid healthcare consultations.

60. The method of providing a plurality of prepaid healthcare consultations as described in claim 59, wherein the step of recharging the at least one of the prepaid healthcare patient identifiers further includes the step of using the telephone and the predetermined combination of numbers on the telephone to access the database and purchase another plurality of prepaid healthcare consultations.
